(19) United States
(12) Patent Application Publication
(10) Pub. No.: US 2023/0072004 A1
(43) Pub. Date: Mar. 9, 2023

(54) CHOCOLATE COMPOSITIONS

(71) Applicant: DOJO BRANDS LLC, Chicago, IL (US)

(72) Inventors: Douglas BOUTON, Holland, MI (US); Kelsey MOCK, Lake Forest, CA (US)

(73) Assignee: DOJO BRANDS LLC, Chicago, IL (US)

(21) Appl. No.: 17/957,758

(22) Filed: Sep. 30, 2022

Related U.S. Application Data
(63) Continuation-in-part of application No. PCT/US22/31137, filed on May 26, 2022.
(60) Provisional application No. 63/193,193, filed on May 26, 2021.

(51) Int. Cl. A23G 1/40; A23G 1/38; A23G 1/46

(52) U.S. Cl. CPC A23G 1/40; A23G 1/38; A23G 1/46; A23V 2002/00

(57) ABSTRACT

The invention relates to chocolate compositions comprising a fat composition, at least one added sweetener, and, optionally, cocoa butter, cocoa powder, and/or milk solids. The added sweetener comprises a sugar alternative and, optionally, sucrose. A chocolate composition of the invention has at least one of a net carbohydrate rare sugar index of less than or equal to 1, a net carbohydrate sugar alcohol index of less than or equal to 1, and a sugar alternative caloric index of less than or equal to 30 cal/g. The invention also relates to chocolate confectionaries made with such chocolate compositions.

### CROSS REFERENCE TO RELATED APPLICATIONS

This application is a Continuation in Part of PCT International Application No. PCT/US2022/031137, filed on May 26, 2022; which claims priority to U.S. Provisional Application No. 63/193,193, filed on May 26, 2021, the disclosures of which are incorporated by reference.

### TECHNICAL FIELD

The invention relates to chocolate compositions comprising, consisting essentially of, or consisting of a fat composition, an added sweetener, and, optionally, cocoa butter, cocoa powder, and/or milk solids, where the added sweetener is a sugar alternative and, optionally, sucrose. The invention also relates to chocolate confectionaries of such chocolate compositions.

### BACKGROUND

Chocolate is a food with high fat and high energy contents. The common classifications of chocolate are, for example, “white”, “plain” or “dark”, or “milk” depending upon the amount of cocoa solids present in the chocolate. Plain chocolate typically has a high percentage of cocoa solids (minimum 30%, and not less than 12% dry, non-fat cocoa solids); milk chocolate may have a lower cocoa solids content (minimum 25%, and not less than 2.5% dry, non-fat cocoa solids), and white chocolate is prepared from cocoa butter (minimum 20%) and not less than 14% milk solids. In the context of the invention, these definitions are not to be construed as being limiting and references to “chocolate” should be understood to include any preparation of dry cocoa solids, non-fat cocoa solids and cocoa butter. All these chocolates may contain filling ingredients such as caramel, coconut, almonds, peanuts, peanut butter, hazel nuts, crisped rice, desiccated fruit, or the like.

A typical process for making chocolate involves two steps: (1) milling the chocolate and (2) molding the chocolate. Milling the chocolate involves batching and mixing together all of the ingredients, milling the batch to reduce the particle size, and often further mixing, milling, and then heating the batch to ensure smooth consistency, small particle size, and liquid form. Molding involves depositing the heated chocolate in liquid form so it can be formed and cooled in a mold such as a bar form. Once cooled, the chocolate is de-molded, meaning removed from the mold. For the milling and molding process, standard operating procedures (like temperatures), methods, and equipment may vary.

Sucrose has been the traditional sweetener used since the beginning of the chocolate industry. Its organoleptic and technological properties render it particularly suitable. However, its nutritional properties may be open to criticism. Indeed, sucrose has a calorific value of 4 kcal/g, which gives to the chocolate, of which sucrose is an essential constituent, a high calorific value. Moreover, it is known that sucrose is completely contraindicated for diabetics because the glucose constituting it can be rapidly assimilated by the organism, which may generate severe hyperglycemia in these patients. Finally, sucrose is a substrate which can be fermented by the commensal bacteria in the mouth, which convert it to corrosive acids which are responsible for tooth decay.

There is a need, therefore, for low-calorie and low-sugar chocolate that retains the taste and feel of traditional chocolate.

### SUMMARY OF THE INVENTION

The invention relates to chocolate compositions comprising, consisting essentially of, or consisting of a fat composition, optionally, cocoa butter, optionally, cocoa powder, at least one added sweetener, and, optionally, milk solids. The fat composition used in the invention does not comprise cocoa butter. The added sweetener comprises, consists essentially of, or consists of a sugar alternative and, optionally, sucrose. The sugar alternative is selected from the group consisting of at least one sugar alcohol, at least one rare sugar, at least one high-intensity sweetener, and mixtures thereof. A chocolate composition of the invention is characterized by at least one of:

a net carbohydrate rare sugar (NCRS) index of less than or equal to 1,

a net carbohydrate sugar alcohol (NCSA) index of less than or equal to 1, and

a sugar alternative caloric (SAC) index of less than or equal to 30 cal/g.

The invention also relates to a chocolate confectionary made with a chocolate composition of the invention.

### BRIEF DESCRIPTION OF THE FIGURES

FIG. 1 depicts the nutrition facts for the milk chocolate bar of Example 1.

FIG. 2 depicts the nutrition facts for the dark chocolate bar of Example 2.

FIG. 3 depicts the nutrition facts for the milk chocolate bar of Example 3.

FIG. 4 depicts the nutrition facts for the milk chocolate bar of Example 4.

FIG. 5 depicts the nutrition facts for the milk chocolate bar of Example 5.

FIG. 6 depicts the nutrition facts for the milk chocolate bar of Example 6.

FIG. 7 depicts the nutrition facts for the dark chocolate bar of Example 7.

FIG. 8 depicts the nutrition facts for the dark chocolate bar of Example 8.

FIG. 9 depicts the nutrition facts for the dark chocolate bar of Example 9.

FIG. 10 depicts the nutrition facts for the dark chocolate bar of Example 10.

### DETAILED DESCRIPTION OF THE INVENTION

A typical chocolate composition has three basic ingredients, cocoa powder (absent in white chocolate), cocoa butter or another vegetable oil, and added sweetener. When any of the ingredients in a chocolate composition is adjusted, the melting point of the chocolate composition is impacted. The fat source is the most impactive factor in determining the melting point of the chocolate composition, and the overwhelming majority of chocolate compositions, including the chocolate compositions for reduced-sugar or no-sugar-added chocolate compositions, are made with cocoa butter as the exclusive source of fat. The target melting point for ideal mouthfeel in a chocolate composition is slightly lower than human body temperature (e.g., 86-90° F.). A distinct advantage of a chocolate composition of the invention is the inclusion of a fat composition as a complete or partial substitute for cocoa butter that still produces a chocolate that maintains ideal mouthfeel for chocolate even despite the use of sugar alternatives.

The invention relates to a chocolate composition and to chocolate confectionaries made with a chocolate composition of the invention. A chocolate composition of the invention comprises, consists essentially of, or consists of a fat composition, optionally, cocoa butter, optionally, cocoa powder, at least one added sweetener, and, optionally, milk solids. The fat composition used in the invention does not comprise cocoa butter. The added sweetener comprises, consists essentially of, or consists of a sugar alternative and, optionally, sucrose. The sugar alternative is selected from the group consisting of at least one sugar alcohol, at least one rare sugar, at least one high-intensity sweetener, and mixtures thereof. A chocolate composition of the invention is characterized by at least one of:

a net carbohydrate rare sugar (NCRS) index of less than or equal to 1,

a net carbohydrate sugar alcohol (NCSA) index of less than or equal to 1, and

a sugar alternative caloric (SAC) index of less than or equal to 30 cal/g.

The chocolate composition of the invention does not necessarily comply with the standard of identity (SOI) for chocolate as established by the United States FDA.

As defined herein, the term “weight percentage” or “wt. %” refers to a way of representing the concentration of a compound or a component in a mixture. Weight percentage is calculated as the mass of a component divided by the total mass of the mixture, multiplied by 100 (wt. %).

As defined herein, the term “mouthfeel” refers to the physical sensations in the mouth caused by food or drink, as distinct from taste. It is a fundamental sensory attribute which, along with taste and smell, determines the overall flavor of a food item.

### The Fat Composition

In a chocolate composition of the invention, the fat composition does not comprise cocoa butter. As used herein, the term “fat composition” means a mixture of fats derived from a plant or animal source that is not cocoa butter. For example, the fat composition may comprise, consist essentially of, or consist of at least one butter, at least one vegetable oil or fat, or mixtures thereof. The fat composition may be present in an amount up to 60 wt. %, based on the total weight of the chocolate composition. For example, the fat composition may be present in an amount of about 0.1-60 wt. %, about 5-55 wt. % wt. %, about 10-50 wt. %, about 15-45 wt. %, about 20-40 wt. %, or about 25-35 wt. %. Preferably, the fat composition is present in an amount of about 5-30 wt. %. When cocoa butter is present in a chocolate composition of the invention, the cocoa butter and the fat composition may be present in a ratio of about 5:1 to about 1:1 (e.g., 4:1, 3:1, 2:1).

The term “fat composition” as used herein does not refer to lecithins or other emulsifying agents that may be present in a chocolate composition of the invention.

The fat composition may comprise, consist essentially of, or consists of at least one butter. As used herein, the term “butter” may refer to a dairy butter, or non-dairy butter that is solid or semi-solid at room temperature. The non-dairy butter may be, e.g., coconut butter, mango butter, or shea butter.

The fat composition may comprise, consist essentially of, or consists of at least one vegetable oil. As used herein, the term “vegetable oil” may refer to any fats derived from vegetables and/or other plants that are liquid at room temperature. The vegetable oil may be selected from the group consisting of palm oil, palm kernel oil, coconut oil, soybean oil, canola oil, sunflower oil, MCT oil, and mixtures thereof. Other potential vegetable oils may be cottonseed oil, illipe oil, mango seed oil, sal oil, and kokum oil.

In one embodiment, a chocolate composition of the invention comprises coconut oil in an amount of at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. % based on the total weight of the chocolate composition.

### Cocoa Butter

In a chocolate composition of the invention, cocoa butter may or may not be present. When cocoa butter is present, it may be present in an amount of about 0.1-40 wt. %, based on the total weight of the chocolate composition. For example, the cocoa butter may be present in an amount of about 0.5-35 wt. %, about 1-30 wt. %, about 2-25 wt. %, about 4-20 wt. %, or about 5-15 wt. %. Preferably, the cocoa powder, when present, is present in an amount of about 20-40 wt. %.

### Cocoa Powder

In a chocolate composition of the invention, cocoa powder may or may not be present. A chocolate composition of the invention comprises cocoa powder particularly when the chocolate composition is a dark chocolate or a milk chocolate composition. When cocoa powder is present, it may be present in an amount of about 0.1-50 wt. %, based on the total weight of the chocolate composition. For example, cocoa powder may be present in an amount of about 0.5-45 wt. %, about 1-40 wt. %, about 5-35 wt. %, about 8-30 wt. %, about 10-25 wt. %, or about 12-20 wt. %. Preferably, the cocoa powder, when present, is present in an amount of about 5-10 wt. % when the chocolate composition is a milk chocolate composition or about 20-30 wt. % when the chocolate composition is a dark chocolate composition.

### The Added Sweetener

In a chocolate composition of the invention, the at least one added sweetener comprises, consists essentially of, or consists of a sugar alternative selected from the group consisting at least one sugar alcohol, at least one rare sugar, at least one high-intensity sweetener, and mixtures thereof, and, optionally, sucrose. The added sweetener may be present in an amount of about 0.1-50 wt. %, based on the total weight of the chocolate composition. For example, the added sweetener may be present in an amount of about 0.5-45 wt. %, about 1-40 wt. %, about 5-35 wt. %, about 10-30 wt. %, about 15-25 wt. %, or about 18-20 wt. %. Preferably, the at least one added sweetener is present in an amount of about 20-35 wt. % when the chocolate composition is a milk chocolate composition or about 10-30 wt. % when the chocolate composition is a dark chocolate composition.

As used herein, the term “sugar alcohol” refers to organic compounds, typically derived from sugars, containing one hydroxyl group (—OH) attached to each carbon atom. They are generally white, water-soluble solids that can occur naturally or produced industrially by hydrogenation of sugars. Sugar alcohols are used widely in the food industry as thickeners and sweeteners. Examples include mannitol, sorbitol, xylitol, lactitol, isomalt, erythritol, maltitol, and hydrogenated starch hydrolysates (HSH). When the sugar alternative comprises, consists essentially of, or consists of a sugar alcohol, the sugar alcohol may be selected from the group consisting of mannitol, sorbitol, xylitol, lactitol, isomalt, erythritol, maltitol, hydrogenated starch hydrolysates (HSH), and mixtures thereof.

As used herein, the term “rare sugars” refer to monosaccharides and their derivatives that seldom occur in nature. Typically, rare sugars are made through biological processes such as fermentation or enzyme conversion to create the identical compound as found in nature. Examples include D-psicose (also known as allulose), D-tagatose, D-allose, D-ribose, and melezitose. When the sugar alternative comprises, consists essentially of, or consists of a rare sugar, the rare sugar may be selected from the group consisting of allulose, tagatose, and mixtures thereof.

As used herein, the term “high-intensity sweetener” refers to an ingredient that is many times sweeter than sugar but contributes only a few to no calories when added to foods. Such high-intensity sweeteners may be about 50 to about 2,000 times sweeter than sugar. Examples include Stevia extract (Stevia), monk fruit extract, Reb M Steviol Glycoside, sucralose, neotame, aspartame, advantame and acesulfame potassium, thaumatin, etc. High potency sweeteners are chemically different from sugars and are not classified as sugars. They may be natural or artificial. When the sugar alternative comprises, consists essentially of, or consists of a high-intensity sweetener, the high-intensity sweetener may be selected from the group consisting of monk fruit extract, Stevia extract (Stevia), sucralose, neotame, aspartame, advantame, thaumatin, acesulfame potassium, and mixtures thereof.

When sucrose is present in the added sweetener, the sucrose may be in the form of refined sugar, unrefined sugar, raw sugar, brown sugar, etc. Additionally, when sucrose is present, the ratio of the sucrose to the sugar alternative may range from about 1:2 to about 1:6. For example, the ratio of the sucrose to the sugar alternative may be about 1:2, about 1:2.5, about 1:3, about 1:3.5, about 1:4, about 1:4.5, about 1:5, about 1:5.5, or about 1:6.

### Milk Solids

In a chocolate composition of the invention, milk solids may or may not be present. Milk solids, including milk fats, typically present in milk or white chocolate compositions, do not operate as complete or partial constituents for the fat composition of a chocolate composition of the invention. A chocolate composition of the invention comprises milk solids particularly when the chocolate composition is a white chocolate or a milk chocolate composition. When the milk solids are present, they may be present in an amount of about 0.1-30 wt. %, based on the total weight of the chocolate composition. For example, milk solids may be present in an amount of about 0.5-25 wt. %, about 1-20 wt. %, 2-15 wt. %, about 3-10 wt. %, or about 4-8 wt. %. Preferably, the milk solids, when present, are present in an amount of about 5-15 wt. %.

### The Net Carbohydrate Rare Sugar (NCRS), Net Carbohydrate Sugar Alcohol (NCSA), and Sugar Alternative Caloric (SAC) Indices

A chocolate composition of the invention is characterized by at least one of three indices. A chocolate composition may also be defined by any two or even all three indices. These indices are the net carbohydrate rare sugar (NCRS) index, net carbohydrate sugar alcohol (NCSA), and the sugar alternative caloric (SAC) index.

The net carbohydrate rare sugar index (NCRS) is equal to Total Net Carbohydrates/Total Rare Sugar Carbohydrates. A chocolate composition of the invention may be characterized by an NCRS index of less than or equal to 1; less than or equal to 0.9, 0.8, 0.7, 0.6, 0.5 or 0.4; or the NCRS may be in the range of about 0.4 to about 1, or of about 0.4 to about 0.6. A chocolate composition of the invention characterized by having an NCRS index of less than or equal to 1 has the advantage of contributing positively to both glycemic control (due to sugar reduction) and weight loss (due to calorie and net carb reduction).

The net carbohydrate sugar alcohol index (NCSA) is equal to Total Net Carbohydrates/Total Sugar Alcohol Carbohydrates. A chocolate composition of the invention may be characterized by an NCSA index of less than or equal to 1; less than or equal to 0.9, 0.8, 0.7, 0.6, 0.5 or 0.4; or the NCSA may be in the range of about 0.4 to about 1, or of about 0.4 to about 0.6. A chocolate composition of the invention characterized by having an NCSA index of less than or equal to 1 has the advantage of contributing positively to both glycemic control (due to sugar reduction) and weight loss (due to calorie and net carb reduction).

The sugar alternative caloric index (SAC) is the total calories/the gram weight of the total sugar alternatives. A chocolate composition of the invention may be characterized by an SAC index of less than or equal to 30 cal/g. For example, the SAC index of a chocolate composition of the invention may be less than or equal to 27.5, less than or equal to 25, less than or equal to 22.5, less than or equal to 20, less than or equal to 15, or less than or equal to 10 cal/g. Milk chocolate compositions may have a higher SAC (in the range of about 20 to about 30 cal/g) than dark chocolates which may have an SAC below 15 cal/g or below 10 cal/g. A chocolate composition of the invention characterized by having a SAC index of less than or equal to 30 cal/g has the advantage contributing positively to both glycemic control (due to sugar reduction) and weight loss (due to calorie and net carb reduction).

In some embodiments, the chocolate compositions of the invention do not contain a rice derivative. The rice derivative may be rice flour or rice extract or powder for the preparation of rice-based beverages. In some embodiments, a chocolate composition of the invention may comprise substantially none or a negligible amount of the rice derivative. For example, the chocolate composition may comprise a rice derivative in an amount of less than 5 wt. %, less then 4 wt. %, less than 3 wt. %, less than 2 wt. %, less than 1 wt. %, less than 0.5 wt. %, less than 0.1 wt. %, or less than 0.01 wt. %, based on the total weight of the chocolate composition.

In some embodiments, the chocolate compositions of the invention do not contain a lactic acid bacterium. The lactic acid bacterium may be a Lactobacillus bacteria (Lactobacillus acidophilus, Lacticaseibacillus casei (Lactobacillus casei), Lactobacillus delbrueckii subsp. bulgaricus (Lactobacillus bulgaricus), Lactobacillus helveticus), Lactococcus lactis, Bacillus amyloliquofaciens, and Streptococcus salivarius subsp. thermophilus (Streptococcus thermophilus), or the like. In some embodiments, a chocolate composition of the invention may comprise substantially none or a negligible amount of the lactic acid bacterium. For example, the chocolate composition may comprise a lactic acid bacterium in an amount of less than 5 wt. %, less than 4 wt. %, less than 3 wt. %, less than 2 wt. %, less than 1 wt. %, less than 0.5 wt. %, less than 0.1 wt. %, or less than 0.01 wt. %, based on the total weight of the chocolate composition.

In some embodiments, chocolate compositions of the invention may have a melting point of about 86-90° F.

In some embodiments, chocolate compositions of the invention may not contain milk fat and/or sucrose (other than as part of the added sweetener, if sucrose is to be included).

Chocolate compositions of the invention may also comprise some amount of an emulsifier (e.g., soy lecithin, sunflower lecithin, rapeseed lecithin or vegetable lecithin) allowing the chocolate to withstand heat. Flavorings (both natural and artificial) may be added to chocolate. Chocolate compositions may comprise filling ingredients such as caramel, coconut, almonds, peanuts, peanut butter, hazel nuts, crisped rice, fruit, desiccated fruit, or the like. Filling ingredients may be whole, halved, chopped, dried, etc. Typically formed in molds, chocolate confectionaries come in a variety of shapes and sizes. Common shapes include bars, drops, balls, ovals, squares, etc. Chocolate confectionaries of the invention may be of any shape.

A chocolate composition of the invention and a chocolate confectionary of the invention may be made using techniques known in the art.

### EXAMPLES

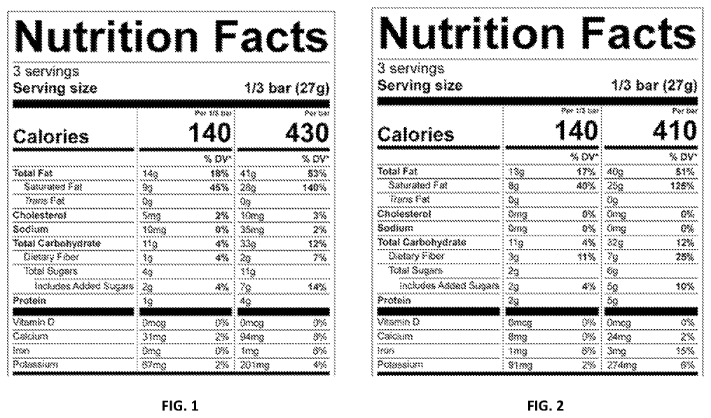

Exemplary chocolate bars may be prepared using the ingredients listed in the examples below using a typical chocolate manufacturing method. The ingredients are mixed, then milled, then allowed to cool before being placed in bar molds. Tables 1-10 list the ingredients in each exemplary chocolate composition. The Nutrition Facts for each exemplary chocolate bars are also shown in each example are shown in FIGS. 1-10. The % Daily Value (DV) in FIGS. 1-10 indicates how much a nutrient in a serving of food contributes to a daily diet; 2,000 calories a day is used for general nutrition advice.

### Example 1: Milk Chocolate Bar I

The nutrition facts are depicted in FIG. 1.

TABLE 1
Milk Chocolate Bar I Composition

| Ingredient | (wt. %) |
|---|---|
| Allulose | 24.94 |
| Whole Milk Powder | 11.97 |
| Organic Sugar (Sucrose) | 8.98 |
| Cocoa Butter | 39.88 |
| Cocoa Powder | 5.99 |
| MCT Oil | 8.00 |
| Organic Sunflower Lecithin | 0.15 |
| Vanilla extract | 0.10 |

### Example 2: Dark Chocolate Bar I

The nutrition facts are depicted in FIG. 2.

TABLE 2
Dark Chocolate Bar I Composition

| Ingredient | (wt. %) |
|---|---|
| Allulose | 18.85 |
| Dry Roasted Diced Almonds | 9.98 |
| Organic Sugar (Sucrose) | 6.28 |
| Cocoa Butter | 34.20 |
| Cocoa Powder | 22.45 |
| MCT Oil | 8.00 |
| Organic Sunflower Lecithin | 0.15 |
| Vanilla extract | 0.10 |

### Example 3: Milk Chocolate Bar II

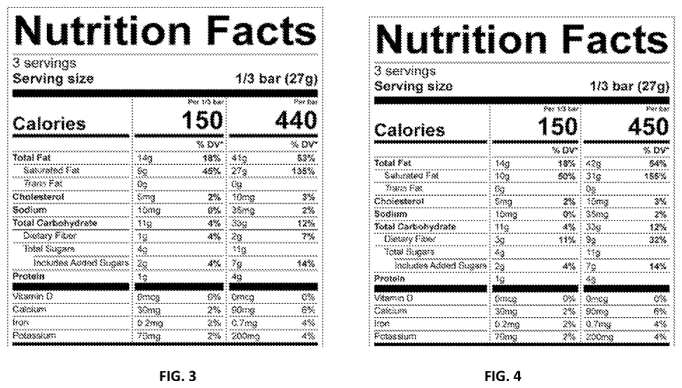

The nutrition facts are depicted in FIG. 3.

TABLE 3
Milk Chocolate Bar II Composition

| Ingredient | (wt. %) |
|---|---|
| Allulose | 24.94 |
| Whole Milk Powder | 11.97 |
| Organic Sugar (Sucrose) | 8.98 |
| Soluble Corn Fiber | 0.00 |
| Cocoa Butter | 39.88 |
| Palm Oil | 8.00 |
| Cocoa Powder | 5.99 |
| Stevia | 0.00 |
| Monk fruit extract | 0.00 |
| Organic Sunflower Lecithin | 0.15 |
| Vanilla Extract | 0.10 |

### Example 4: Milk Chocolate Bar III

The nutrition facts are depicted in FIG. 4.

TABLE 4
Milk Chocolate Bar III Composition

| Ingredient | (wt. %) |
|---|---|
| Erythritol | 15.00 |
| Whole Milk Powder | 11.97 |
| Organic Sugar (Sucrose) | 8.98 |
| Soluble Corn Fiber | 9.90 |
| Cocoa Butter | 23.94 |
| Coconut Oil | 23.94 |
| Cocoa Powder | 5.99 |
| Stevia | 0.02 |
| Monk fruit extract | 0.02 |
| Organic Sunflower Lecithin | 0.15 |
| Vanilla Extract | 0.10 |

### Example 5: Milk Chocolate Bar IV

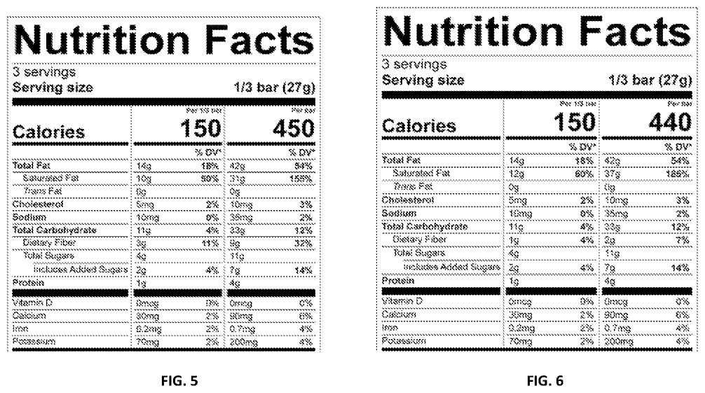

The nutrition facts are depicted in FIG. 5.

TABLE 5
Milk Chocolate Bar IV Composition

| Ingredient | (wt. %) |
|---|---|
| Allulose | 15.00 |
| Whole Milk Powder | 11.97 |
| Organic Sugar (Sucrose) | 8.98 |
| Soluble Corn Fiber | 9.90 |
| Cocoa Butter | 23.94 |
| Coconut Oil | 23.94 |
| Cocoa Powder | 5.99 |
| Stevia | 0.02 |
| Monk fruit extract | 0.02 |
| Organic Sunflower Lecithin | 0.15 |
| Vanilla Extract | 0.10 |

### Example 6: Milk Chocolate Bar V

The nutrition facts are depicted in FIG. 6.

TABLE 6
Milk Chocolate Bar V Composition

| Ingredient | (wt. %) |
|---|---|
| Allulose | 24.94 |
| Whole Milk Powder | 11.97 |
| Organic Sugar (Sucrose) | 8.98 |
| Soluble Corn Fiber | 0.00 |
| Palm Oil | 23.94 |
| Coconut Butter | 23.94 |
| Cocoa Powder | 5.99 |
| Stevia | 0.00 |
| Monk fruit extract | 0.00 |
| Organic Sunflower Lecithin | 0.15 |
| Vanilla Extract | 0.10 |

### Example 7: Dark Chocolate Bar II

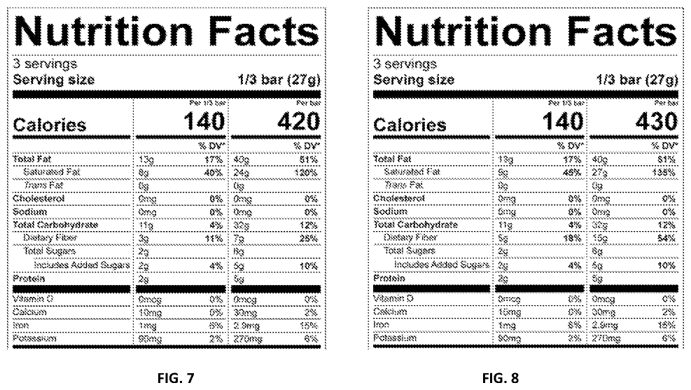

The nutrition facts are depicted in FIG. 7.

TABLE 7
Dark Chocolate Bar III Composition

| Ingredient | (wt. %) |
|---|---|
| Allulose | 18.85 |
| Dry Roasted Diced Almonds | 9.98 |
| Organic Sugar (Sucrose) | 6.28 |
| Soluble Corn Fiber | 0.00 |
| Cocoa Butter | 34.20 |
| Palm Oil | 8.00 |
| Cocoa Powder | 22.45 |
| Stevia | 0.00 |
| Monk fruit extract | 0.00 |
| Organic Sunflower Lecithin | 0.15 |
| Vanilla Extract | 0.10 |

### Example 8: Dark Chocolate Bar III

The nutrition facts are depicted in FIG. 8.

TABLE 8
Dark Chocolate Bar III Composition

| Ingredient | (wt. %) |
|---|---|
| Erythritol | 8.85 |
| Dry Roasted Diced Almonds | 9.98 |
| Organic Sugar (Sucrose) | 6.28 |
| Soluble Corn Fiber | 9.96 |
| Cocoa Butter | 21.10 |
| Coconut Oil | 21.10 |
| Cocoa Powder | 22.45 |
| Stevia | 0.02 |
| Monk fruit extract | 0.02 |
| Organic Sunflower Lecithin | 0.15 |
| Vanilla Extract | 0.10 |

### Example 9: Dark Chocolate Bar IV

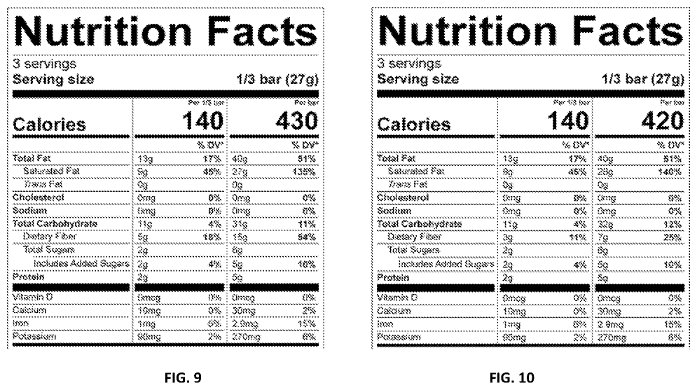

The nutrition facts are depicted in FIG. 9.

TABLE 9
Dark Chocolate Bar IV Composition

| Ingredient | (wt. %) |
|---|---|
| Allulose | 8.85 |
| Dry Roasted Diced Almonds | 9.98 |
| Organic Sugar (Sucrose) | 6.28 |
| Soluble Corn Fiber | 9.96 |
| Cocoa Butter | 21.10 |
| Coconut Oil | 21.10 |
| Cocoa Powder | 22.45 |
| Stevia | 0.02 |
| Monk fruit extract | 0.02 |
| Organic Sunflower Lecithin | 0.15 |
| Vanilla Extract | 0.10 |

### Example 10: Dark Chocolate Bar V

The nutrition facts are depicted in FIG. 10.

TABLE 10
Dark Chocolate Bar V Composition

| Ingredient | (wt. %) |
|---|---|
| Allulose | 18.85 |
| Dry Roasted Diced Almonds | 9.98 |
| Organic Sugar (Sucrose) | 6.28 |
| Soluble Corn Fiber | 0.00 |
| Palm Oil | 21.10 |
| Coconut Butter | 21.10 |
| Cocoa Powder | 22.45 |
| Stevia | 0.00 |
| Monk fruit extract | 0.00 |
| Organic Sunflower Lecithin | 0.15 |
| Vanilla Extract | 0.10 |

### Summary Data

Table 11 shows the composition summary data as well as the net carbohydrate rare sugar (NCRS), net carbohydrate sugar alcohol (NCSA), and sugar alternative caloric (SAC) indices for Examples 1-10.

TABLE 11
Summary Table

Chocolate

| | Ex. 1 - | Ex. 2 - |
|---|---|---|
| | Milk I | Dark I |
| Serving (g) | 27 | 27 |
| Calories | 140 | 140 |
| Total Carb | 11 | 11 |
| Fiber | 1 | 3 |
| Sugar | 4 | 2 |
| Added sweetener | 2 | 2 |
| Allulose | 6.7 | 5.1 |
| Erythritol | 0 | 0 |
| Maltitol | 0 | 0 |
| Tagatose | 0 | 0 |
| Stevia | 0 | 0 |
| Monk fruit extract | 0 | 0 |
| Net Carbs | 3.3 | 2.9 |
| MCT Oil | Yes | Yes |
| NCRS Index | 0.49 | 0.57 |
| NCSA Index | CBD | CBD |
| SAC Index | 20.8 | 27.5 |

Chocolate

| | Ex. 3 - | Ex. 4 - | Ex. 5 - | Ex. 6 - |
|---|---|---|---|---|
| | Milk II | Milk III | Milk IV | Milk V |
| Serving (g) | 27 | 27 | 27 | 27 |
| Calories | 150 | 150 | 150 | 150 |
| Total Carb | 11 | 11 | 11 | 11 |
| Fiber | 1 | 3 | 3 | 1 |
| Sugar | 4 | 4 | 4 | 4 |
| Added sweetener | 6.7 | 4.1 | 4.1 | 6.7 |
| Allulose | 6.7 | 0 | 4.1 | 6.7 |
| Erythritol | 0 | 4.1 | 0.0 | 0 |
| Maltitol | 0 | 0 | 0 | 0 |
| Tagatose | 0 | 0 | 0 | 0 |
| Stevia | 0 | 0.01 | 0.01 | 0 |
| Monk fruit extract | 0 | 0.01 | 0.01 | 0 |
| Net Carbs | 3 | 4 | 4 | 3 |
| MCT Oil | No | No | No | No |
| NCRS Index | 0.49 | CBD | 0.98 | 0.49 |
| NCSA Index | CBD | 0.98 | CBD | CBD |
| SAC Index | 22.3 | 36.9 | 36.9 | 22.3 |

Chocolate

| | Ex. 7 - | Ex. 8 - | Ex. 9 - | Ex. 10 - |
|---|---|---|---|---|
| | Dark II | Dark III | Dark IV | Dark V |
| Serving (g) | 27 | 27 | 27 | 27 |
| Calories | 140 | 140 | 140 | 140 |
| Total Carb | 11 | 11 | 11 | 11 |
| Fiber | 3 | 5 | 5 | 3 |
| Sugar | 2 | 2 | 2 | 2 |
| Added sweetener | 6.7 | 4.1 | 4.1 | 6.7 |
| Allulose | 6.7 | 0.0 | 4.1 | 6.7 |
| Erythritol | 0 | 4.1 | 0 | 0 |
| Maltitol | 0 | 0 | 0 | 0 |
| Tagatose | 0 | 0 | 0 | 0 |
| Stevia | 0 | 0 | 0 | 0 |
| Monk fruit extract | 0 | 0 | 0 | 0 |
| Net Carbs | 1 | 2 | 2 | 1 |
| MCT Oil | No | No | No | No |
| NCRS Index | 0.19 | CBD | 0.48 | 0.19 |
| NCSA Index | CBD | 0.48 | CBD | CBD |
| SAC Index | 20.8 | 34.5 | 34.5 | 20.8 |

CBD—Cannot be determined, divisible by zero.

Table 12 shows composition summary data as well as the net carbohydrate rare sugar (NCRS), net carbohydrate sugar alcohol (NCSA), and sugar alternative caloric (SAC) indices for state-of-the-art chocolate compositions from Lily's (https://lilys.com/) and Skinny Dipped (https://skinnydipped.com/).

TABLE 12
Comparative Chocolates

| | Comparative Chocolate | | | | |
|---|---|---|---|---|---|
| | Lily's | Lily's | Lily's | | Skinny |
| | Dark | Original | Caramel | Lily's | Dipped |
| | Almond | Dark | Milk | Milk | Dark |
| Serving (g) | 30 | 30 | 30 | 30 | 30 |
| Calories | 140 | 130 | 130 | 130 | 140 |
| Total Carb | 15 | 16 | 17 | 17 | 12 |
| Fiber | 9 | 10 | 10 | 10 | 4 |
| Sugar | 0 | 0 | 0 | 0 | 3 |
| Added sweetener | 0 | 0 | 0 | 0 | 3 |
| Allulose | 0 | 0 | 0 | 0 | 2.5 |
| Erythritol | 3 | 4 | 5 | 5 | 0 |
| Maltitol | 0 | 0 | 0 | 0 | 0 |
| Tagatose | 0 | 0 | 0 | 0 | 0 |
| Net Carbs | 3 | 2 | 2 | 2 | 5.5 |
| NCRS Index | CBD | CBD | CBD | CBD | 2.2 |
| NCSA Index | 1.00 | 0.5 | 0.4 | 0.4 | CBD |
| SAC Index | 46.7 | 32.5 | 26 | 26 | 56 |

CBD—Cannot be determined, divisible by zero.

### Exemplary Embodiments of the Invention

E1. A chocolate composition comprising, consisting essentially of, or consisting of:
a) a fat composition;
b) optionally, cocoa butter;
c) optionally, cocoa powder;
d) at least one added sweetener; and
e) optionally, milk solids;
wherein the fat composition does not comprise cocoa butter,
wherein the added sweetener comprises, consists essentially of, or consists of:
   a sugar alternative selected from the group consisting of at least one sugar alcohol, at least one rare sugar, at least one high-intensity sweetener, and mixtures thereof; and optionally, sucrose;
wherein the chocolate composition is characterized by at least one of:
   a net carbohydrate rare sugar (NCRS) index of less than or equal to 1,
   a net carbohydrate rare sugar (NCSA) index of less than or equal to 1, and
   a sugar alternative caloric (SAC) index of less than or equal to 30 cal/g.

E2. The chocolate composition of E1, wherein component a) comprises, consists essentially of, or consists of at least one butter, at least one vegetable fat or oil, or mixtures thereof.

E3. The chocolate composition of E1 or E2, wherein component a) is present in an amount of up to about 60 wt. %, based on the total weight of the chocolate composition.

E4. The chocolate composition of any one of E1-E3, wherein component a) is at least one vegetable oil selected from the group consisting of palm oil, palm kernel oil, coconut oil, soybean oil, canola oil, sunflower oil, MCT oil, and mixtures thereof.

E5. The chocolate composition of any one of E1-E4, wherein component b) is not present.

E6. The chocolate composition of any one of E1-E4, wherein component b) is present in an amount of about 0.1-40 wt. %, based on the total weight of the chocolate composition.

E7. The chocolate composition of any one of E1-E6, wherein component c) is not present.

E8. The chocolate composition of any one of E1-E6, wherein component c) is present in an amount of about 0.1-50 wt. %, based on the total weight of the chocolate composition.

E9. The chocolate composition of any one of E1-E8, wherein the sugar alcohol is selected from a derivative of sugar in which one hydroxyl group is attached to each carbon atom.

E10. The chocolate composition of E9, wherein the sugar alcohol is selected from the group consisting of mannitol, sorbitol, xylitol, lactitol, isomalt, erythritol, maltitol, hydrogenated starch hydrolysates, and mixtures thereof.

E11. The chocolate composition of any one of E1-E10, wherein the rare sugar is selected from the group consisting of allulose, tagatose, and mixtures thereof.

E12. The chocolate composition of any one of E1-E11, wherein the high-intensity sweetener is selected from the group consisting of monk fruit extract, Stevia extract (Stevia), sucralose, neotame, aspartame, advantame, thaumatin, acesulfame potassium, and mixtures thereof.

E13. The chocolate composition of any one of E1-E12, wherein:

the sugar alcohol is erythritol, maltitol, or mixtures thereof; and

the rare sugar is allulose, tagatose, or mixtures thereof.

E14. The chocolate composition of any one of E1-E13, wherein component d) is present in an amount of about 0.1-50 wt. %, based on the total weight of the chocolate composition.

E15. The chocolate composition of any one of E1-E14, wherein component d) comprises about 0.1-50 wt. % of the sugar alcohol, based on the total weight of component d).

E16. The chocolate composition of any one of E1-E15, wherein component d) comprises about 0.1-50 wt. % of the rare sugar, based on the total weight of component d).

E17. The chocolate composition of any one of E1-E16, wherein component d) comprises about 0.1-50 wt. % of the high-intensity sweetener, based on the total weight of component d).

E18. The chocolate composition of any one of E1-E17, wherein component d) comprises about 0.1-50 wt. % of the sucrose, based on the total weight of component d).

E19. The chocolate composition of any one of E1-E18, wherein the ratio of sucrose to the sugar alternative in component d) ranges from about 1:2 to about 1:6.

E20. The chocolate composition of any one of E1-E16, wherein component d) comprises, consists essentially of, or consists of:
about 0-100 wt. % of the sugar alcohol, based on the total weight of component d);
about 0-100 wt. % of the rare sugar, based on the total weight of component d);
about 0-100 wt. % of the high-intensity sweetener, based on the total weight of component d); and
0 wt. % of the sucrose, based on the total weight of component d),

E21. The chocolate composition of E20, wherein the amount of the sugar alcohol, the high-intensity sweetener, and the rare sugar in component d) sum up to 100 wt. %, based on the total weight of component d).

E22. The chocolate composition of any one of E1-E21, wherein component e) is not present.

E23. The chocolate composition of any one of E1-E21, wherein component e) is present in an amount of 0.1-30 wt. %, based on the total weight of the chocolate composition.

E24. The chocolate composition of any one of E1-E23, wherein the chocolate composition is characterized by an NCRS index of less than or equal to 1.

E25. The chocolate composition of any one of E1-E24, wherein the chocolate composition is characterized by an NCSA index of less than or equal to 1.

E26. The chocolate composition of any one of E1-E25, wherein the chocolate composition is characterized by a SAC index of less than or equal to 30 cal/g.

E27. The chocolate composition of E26, wherein the chocolate composition is characterized by a SAC index of less than or equal to 27.5 cal/g.

E28. The chocolate composition of E27, wherein the chocolate composition is characterized by a SAC index of less than or equal to 25 cal/g.

E29. The chocolate composition of E28, wherein the chocolate composition is characterized by a SAC index of less than or equal to 22.5 cal/g.

E30. The chocolate composition of any one of E1-E6, E8-E22, and E24-29, wherein the chocolate composition is dark chocolate.

E31. The chocolate composition of any one of E1-E6, E9-E21, and E23-E29, wherein the chocolate composition is milk chocolate.

E32. The chocolate composition of any one of E1-E7, E9-E21, and E23-E29, wherein the chocolate composition is white chocolate.

E33. The chocolate composition of any one of E1-E32, wherein the melting point for the chocolate composition is about 86-90° F.

E34. A chocolate confectionary comprising, consisting essentially of, or consisting of the chocolate composition of any one of E1-E33.

E35. The chocolate confectionary of E34, wherein the chocolate is filled with a filling ingredient selected from caramel, coconut, almonds, peanuts, peanut butter, hazel nuts, crisped rice, desiccated fruit, or mixtures thereof.

E36. The chocolate confectionary of E34 or E35, wherein the chocolate confectionary is a molded chocolate bar.

The claimed invention is:

1. A chocolate composition comprising:
a) a fat composition;
b) optionally, cocoa butter;
c) optionally, cocoa powder;
d) at least one added sweetener; and
e) optionally, milk solids;
wherein the fat composition does not comprise cocoa butter, wherein the added sweetener comprises:
a sugar alternative selected from the group consisting of at least one sugar alcohol, at least one rare sugar, at least one high-intensity sweetener, and mixtures thereof; and
optionally, sucrose;
wherein the chocolate composition is characterized by at least one of:
a net carbohydrate rare sugar (NCRS) index of less than or equal to 1,
a net carbohydrate sugar alcohol (NCSA) index of less than or equal to 1, and
a sugar alternative caloric (SAC) index of less than or equal to 30 cal/g.

2. The chocolate composition of claim 1, wherein component a) comprises at least one butter, at least one vegetable fat or oil, or mixtures thereof.

3. The chocolate composition of claim 1, wherein component a) is present in an amount of up to about 60 wt. %, based on the total weight of the chocolate composition.

4. The chocolate composition of claim 1, wherein component a) is at least one vegetable oil selected from the group consisting of palm oil, palm kernel oil, coconut oil, soybean oil, canola oil, sunflower oil, MCT oil, and mixtures thereof.

5. The chocolate composition of claim 1, wherein component b) is not present.

6. The chocolate composition of claim 1, wherein component b) is present in an amount of about 0.1-40 wt. %, based on the total weight of the chocolate composition.

7. The chocolate composition of claim 1, wherein component c) is not present.

8. The chocolate composition of claim 1, wherein component c) is present in an amount of about 0.1-50 wt. %, based on the total weight of the chocolate composition.

9. The chocolate composition of claim 1, wherein the sugar alcohol is selected from a derivative of sugar in which one hydroxyl group is attached to each carbon atom.

10. The chocolate composition of claim 9, wherein the sugar alcohol is selected from the group consisting of mannitol, sorbitol, xylitol, lactitol, isomalt, erythritol, maltitol, hydrogenated starch hydrolysates, and mixtures thereof.

11. The chocolate composition of claim 1, wherein the rare sugar is selected from the group consisting of allulose, tagatose, and mixtures thereof.

12. The chocolate composition of claim 1, wherein the high-intensity sweetener is selected from the group consisting of monk fruit extract, Stevia extract (Stevia), sucralose, neotame, aspartame, advantame, thaumatin, acesulfame potassium, and mixtures thereof.

13. The chocolate composition of claim 1, wherein:
the sugar alcohol is erythritol, maltitol, or mixtures thereof; and
the rare sugar is allulose, tagatose, or mixtures thereof.

14. The chocolate composition of claim 1, wherein component d) is present in an amount of about 0.1-50 wt. %, based on the total weight of the chocolate composition.

15. The chocolate composition of claim 1, wherein component d) comprises about 0.1-50 wt. % of the sugar alcohol, based on the total weight of component d).

16. The chocolate composition of claim 1, wherein component d) comprises about 0.1-50 wt. % of the rare sugar, based on the total weight of component d).

17. The chocolate composition of claim 1, wherein component d) comprises about 0.1-50 wt. % of the high-intensity sweetener, based on the total weight of component d).

18. The chocolate composition of claim 1, wherein component d) comprises about 0.1-50 wt. % of the sucrose, based on the total weight of component d).

19. The chocolate composition of claim 1, wherein the ratio of sucrose to the sugar alternative in component d) ranges from about 1:2 to about 1:6.

20. The chocolate composition of claim 1, wherein component d) comprises:
about 0-100 wt. % of the sugar alcohol, based on the total weight of component d);
about 0-100 wt. % of the rare sugar, based on the total weight of component d);
about 0-100 wt. % of the high-intensity sweetener, based on the total weight of component d); and
0 wt. % of the sucrose, based on the total weight of component d),
wherein the amount of the sugar alcohol, the high-intensity sweetener, and the rare sugar in component d) sum up to 100 wt. %, based on the total weight of component d).

21. The chocolate composition of claim 1, wherein component e) is present in an amount of 0.1-30 wt. %, based on the total weight of the chocolate composition.

22. The chocolate composition of claim 1, wherein the chocolate composition is characterized by an NCRS index of less than or equal to 1.

23. The chocolate composition of claim 1, wherein the chocolate composition is characterized by an NCSA index of less than or equal to 1.

24. The chocolate composition of claim 1, wherein the chocolate composition is characterized by a SAC index of less than or equal to 30 cal/g.

25. The chocolate composition of claim 1, wherein the chocolate composition is dark chocolate, milk chocolate, or white chocolate.

26. The chocolate composition of claim 1, wherein the melting point for the chocolate composition is about 86-90° F.

27. A chocolate confectionary comprising the chocolate composition of claim 1.

28. The chocolate composition of claim 1, wherein the chocolate composition comprises coconut oil in an amount of at least 10 wt. %, based on the total weight of the chocolate composition.

29. The chocolate composition of claim 1, wherein the chocolate composition does not contain a rice derivative.

30. The chocolate composition of claim 1, wherein the chocolate composition does not contain a lactic acid bacterium.
